(19) United States
(12) Patent Application Publication
(10) Pub. No.: US 2026/0086191 A1
(43) Pub. Date: Mar. 26, 2026

(54) CARRIER PHASE MEASUREMENT USING REFERENCE FREQUENCY AND REFERENCE TIME

(71) Applicant: Lenovo (United States) Inc., Morrisville, NC (US)

(72) Inventors: Colin Frank, Park Ridge, IL (US); Robin Rajan Thomas, Frankfurt (DE)

(73) Assignee: Lenovo (United States) Inc., Morrisville, NC (US)

(21) Appl. No.: 18/893,352

(22) Filed: Sep. 23, 2024

(51) Int. Cl. G01S 5/10; G01S 5/00

(52) U.S. Cl. CPC G01S 5/10; G01S 5/0036

(57) ABSTRACT

Various aspects of the present disclosure relate to carrier phase measurement using reference frequency and reference time. An apparatus, such as a user equipment (UE), receives signaling comprising one or more reference symbols of one or more transmission-reception points (TRPs). The UE transmits signaling comprising a carrier phase measurement generated based at least in part on a carrier phase of the one or more reference symbols relative to a carrier phase of a reference cell of the UE at a reference frequency and a reference time within a measurement time window.

### TECHNICAL FIELD

The present disclosure relates to wireless communications, and more specifically to using carrier phase measurement (e.g., computation, estimation, determination) for device positioning in wireless communications systems.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

The wireless communications system may support wireless communications, and may include one or more devices, such as UEs, base stations (e.g., gNBs), network entities, satellites, and/or network equipment (NE), among other devices, which transmit and/or receive signaling.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein may include a UE for wireless communication to receive signaling including one or more reference symbols of one or more transmission-reception points (TRPs); and transmit signaling including a carrier phase measurement generated based at least in part on a carrier phase of the one or more reference symbols relative to a carrier phase of a reference cell of the UE at a reference frequency and a reference time within a measurement time window.

In some implementations of the method and apparatuses described herein, the reference frequency includes a center frequency of a positioning frequency layer; the reference time includes a center of the measurement time window; the reference time is defined according to one or more combinations of symbol index, slot number, slot offset, system frame number, subframe number, coordinated universal time (UTC) time, or global navigation satellite system (GNSS) time; the one or more reference symbols include one or more downlink positioning reference signals (PRS); the at least one processor is configured to cause the UE to estimate the carrier phase as a weighted combination of phase estimates of the one or more reference symbols; the phase estimates of the one or more reference symbols are generated based at least in part on the reference frequency and the reference time; the at least one processor is configured to cause the UE to generate the carrier phase measurement based at least in part on a carrier phase difference of a first carrier phase of a first TRP and a second carrier phase of a second TRP of the one or more TRPs; the at least one processor is configured to cause the UE to determine the first carrier phase and the second carrier phase relative to the carrier phase of the reference cell; the UE is associated with a positioning reference unit (PRU); the at least one processor is configured to cause the UE to receive third signaling including one or more of the reference frequency or the reference time.

Some implementations of the method and apparatuses described herein may further include a processor for wireless communication to receive signaling including one or more reference symbols of one or more TRPs; and transmit signaling including a carrier phase measurement generated based at least in part on a carrier phase of the one or more reference symbols relative to a carrier phase of a reference cell of a UE at a reference frequency and a reference time within a measurement time window.

Some implementations of the method and apparatuses described herein may further include a method performed by a UE, the method including receiving signaling including one or more reference symbols of one or more TRPs; and transmitting signaling including a carrier phase measurement generated based at least in part on a carrier phase of the one or more reference symbols relative to a carrier phase of a reference cell of the UE at a reference frequency and a reference time within a measurement time window.

In some implementations of the method and apparatuses described herein, the method further comprising where the reference frequency includes a center frequency of a positioning frequency layer; the reference time includes a center of the measurement time window; the reference time is defined according to one or more combinations of symbol index, slot number, slot offset, system frame number, subframe number, UTC time, or GNSS time; the one or more reference symbols include one or more downlink PRS; further including estimating the carrier phase as a weighted combination of phase estimates of the one or more reference symbols; the phase estimates of the one or more reference symbols are generated based at least in part on the reference frequency and the reference time; further including generating the carrier phase measurement based at least in part on a carrier phase difference of a first carrier phase of a first TRP and a second carrier phase of a second TRP of the one or more TRPs; further including determining the first carrier phase and the second carrier phase relative to the carrier phase of the reference cell; the UE is associated with a PRU; further including receiving third signaling including one or more of the reference frequency or the reference time.

Some implementations of the method and apparatuses described herein may further include a NE for wireless communication to transmit signaling including configuration for generating carrier phase measurement at a UE based at least in part on a carrier phase of one or more reference symbols relative to a carrier phase of a reference cell of the UE at a reference frequency and a reference time within a measurement time window.

In some implementations of the method and apparatuses described herein, one or more of: the reference frequency includes a center frequency of a positioning frequency layer; or the reference time includes a center of the measurement time window; the at least one processor is configured to cause the network equipment to: receive, from the UE, signaling including a carrier phase measurement; and estimate a position of the UE based at least in part on the carrier phase measurement.

Some implementations of the method and apparatuses described herein may further include a method performed by a NE, the method including transmitting signaling including configuration for generating carrier phase measurement at a UE based at least in part on a carrier phase of one or more reference symbols relative to a carrier phase of a reference cell of the UE at a reference frequency and a reference time within a measurement time window.

In some implementations of the method and apparatuses described herein, the method further comprising wherein one or more of: the reference frequency includes a center frequency of a positioning frequency layer; or the reference time includes a center of the measurement time window; further including: receiving, from the UE, signaling including a carrier phase measurement; and estimating a position of the UE based at least in part on the carrier phase measurement.

### BRIEF DESCRIPTION OF THE DRAWINGS

FIG. 1 illustrates an example of a wireless communications system in accordance with aspects of the present disclosure.

FIG. 2 illustrates an example of system for NR beam-based positioning in accordance with aspects of the present disclosure.

FIG. 3 illustrates an example of a multi-cell RTT procedure as related to carrier phase positioning configuration in accordance with aspects of the present disclosure.

FIG. 4 illustrates maximum phase error vs. time between DL-PRS symbol from different TRPs (in symbols) in accordance with aspects of the present disclosure

FIG. 5 illustrates an example of a UE in accordance with aspects of the present disclosure.

FIG. 6 illustrates an example of a processor in accordance with aspects of the present disclosure.

FIG. 7 illustrates an example of a NE in accordance with aspects of the present disclosure.

FIG. 8 illustrates a flowchart of a method in accordance with aspects of the present disclosure.

FIG. 9 illustrates a flowchart of a method in accordance with aspects of the present disclosure.

### DETAILED DESCRIPTION

In a wireless communications system, a UE and a NE (e.g., a base station, gNB) may support wireless communication (e.g., reception and/or transmission of wireless communication) using time-frequency resources. Further, time-frequency resources can be used for device positioning, e.g., for determining a position of a UE. One example positioning technique that utilizes time-frequency resources is carrier phase positioning, which is employed in GNSS such as Global Positioning System (GPS), Galileo, etc. Carrier phase positioning can involve measuring the phase of satellite transmissions and comparing the satellite transmission phase with the reception phase at a receiver's antenna. In 3GPP Rel-18, for instance, specification of carrier phase positioning is described to complement existing RAT-dependent measurements such as downlink (DL)-reference signal time difference (RSTD), uplink (UL)-relative time of arrival (RTOA), gNB Rx-Tx time difference measurements, UE Rx-Tx time difference measurements, UL-angle of arrival (AoA), and DL-angle of departure (AoD).

One issue in carrier phase positioning is determining how to correct for carrier frequency offsets between the transmission reception points (TRPs) and the receivers of the UEs and the PRUs. For instance, frequency errors within an allowed tolerance (e.g., as defined within 3GPP specification) can result in large carrier phase measurement errors because the transmitter phase difference measured by the PRU on one symbol may not be corrected when applied to a later (e.g., different) symbol, which can result in large phase measurement errors. Further, for the UE and PRU to perform joint measurement of RAT-dependent positioning measurements in time including downlink and uplink Reference Signal Carrier Phase (RSCP) and Reference Signal Carrier Phase Difference (RSCPD), a time window to perform simultaneous measurements can be defined.

Additionally, in some scenarios, uncertainty exists in defining the carrier phase of reference symbols received from a TRP in the presence of a carrier frequency offset. In the absence of carrier frequency offsets, the process of defining the carrier phase of reference symbols received from a TRP typically involves the use of the “double differencing method” to remove the unknown initial phases of the TRP transmitters and the UE and/or PRU receiver. With the double differencing method, the UE measures the carrier phase of reference symbols received from two different TRPs. When the difference of the two UE phase measurements is taken, the initial phase of the receiver is cancelled with the result that the difference reflects the difference in distance between the two TRPs relative to the UE and the difference between the initial phases of the two TRP transmitters. Similarly, the PRU measures the carrier phase of reference symbols from the same two TRPs. When the differences of the two PRU phase measurements is taken, the initial phase of the PRU receiver is cancelled with the result that the difference reflects the difference in distance of the two TRPs relative to the PRU and the difference between the initial phases of the two TRP transmitters. However, because the location of the TRPs and the PRUs are precisely known, the difference in distance between the two TRPs and the PRU is known, and the corresponding phase difference can be determined. By removing the difference in phase due to the differential distance of the two TRPs relative to the PRU from the difference of the PRU phase measurements, the difference in the initial phases of the two TRPs can be determined.

In order to employ the double differencing method to remove the initial phase offsets of the TRP transmitters, both the carrier phase and the carrier phase difference are to be well defined. However, in the presence of carrier frequency offset, the carrier phase of the TRP and the carrier phase difference between two TRPs are continuously changing from symbol to symbol, and thus may not be defined. Thus, there is currently no definition of carrier phase in the 3GPP specification that applies in the presence of a carrier frequency offset between a TRP transmitting reference symbols and a UE or PRU receiving these reference symbols.

The carrier phase of reference symbols received from a TRP can be measured relative to the carrier frequency of the receiving UE or PRU. For instance, the UE and PRU will track the carrier frequency of a reference cell which is the serving cell (e.g., the carrier frequency of the reference cell can be tracked in order to demodulate the data received from the serving cell). The UE and the PRU may have the same or different serving cell. If the UE and the PRU have the same serving cell, then the frequency offsets of the TRPs relative to the UE and the PRU can be the same (e.g., to the extent that the UE and the PRU correctly track the frequency of the serving cell). Conversely, if the UE and the PRU have different serving cells, then the difference between the frequency offsets of the TRPs relative to the UE and the PRU can be equal to the difference in the carrier frequencies of the serving cells for the UE and the PRU.

The present disclosure proposes definitions of carrier phase and carrier phase difference that mitigate ambiguities that can exist in the presence of a carrier frequency offset by associating the definition to a reference time. For instance, the carrier phase of a TRP relative to a UE or PRU can be defined as the carrier phase of reference symbols transmitted by the TRP relative to the carrier phase of the reference cell (e.g., the serving cell) of the UE or PRU at a specified frequency and a specified reference time within a measurement time window. Measurement time windows, for instance, represent specific periods (e.g., slots) when a UE can (e.g., is permitted to) perform measurements on downlink signals, e.g., PRS. Measurement time windows can be configured by the network. Further, the carrier phase difference of two TRPs relative to a UE or PRU can be defined as the difference of the carrier phase of the first TRP and the carrier of the second TRP, where the carrier phase of each TRP can be measured relative to the carrier phase of the reference cell (e.g., the serving cell) at a specified frequency and a specified reference time within a measurement time window.

In cases where the reference time is defined to be the center of the measurement time window, the carrier phase can be defined as the average of the carrier phase over the measurement time window, and similarly, the carrier phase difference can be defined as the difference of the carrier phase averages. The specified reference time can be determined by the Location Measurement Unit (LMU) and signaled to the UE and the PRU. Alternatively, the specified reference time can be determined by default as the center of the measurement time window or other location within the measurement time window.

The present disclosure thus provides that carrier phase and carrier phase difference can be defined at a specific reference time, such as at the center of the measurement time window. The carrier phase can then be defined as the average carrier phase over the measurement time window. With this approach, there is no need to explicitly estimate the carrier frequency offset and remove the carrier phase rotation from the phase measurements, as this phase rotation can average out to zero over the measurement time window. By using a large time window with averaging of the carrier phase measurements, the signal-to-noise ratio of the phase estimate can be improved relative to measurements taken over a shorter time window. Further, in the event that the PRS locations are not completely symmetrical with respect to the center of the time window, the present disclosure discusses how the averaging can be accomplished without explicitly estimating the carrier frequency offset.

To further elaborate, in the present disclosure the carrier phase and carrier phase difference can be defined at a reference time and there may be no need to explicitly refer to measurements taken elsewhere to this reference time. In an example, if the reference time is taken in the center of the measurement time window, then the carrier phase measurements can be averaged and the carrier phase difference can be taken as the difference of the average carrier phase for two different TRPs. Further, if the measurements are not taken symmetrically, then the UE or the PRU can determine how to estimate the carrier phase at the reference time from PRS measurements taken elsewhere. Where PRS measurements are taken on both sides of the reference time, an unbiased estimate of the carrier phase can be produced without the need to estimate the carrier frequency offset.

In implementations where a measurement time window includes multiple consecutive slots, carrier phase can be defined as the carrier phase at the center of the multiple consecutive slots. Alternatively or additionally, carrier phase can be defined as the average of the carrier phase over the measurement time window. With either of these approaches, the carrier phase can be computed as the average of the carrier phase over the measurement time window. As a result, there is no need to explicitly estimate the carrier frequency offset. In the case that the time window includes a single time slot, the carrier phase can be defined as the carrier phase at the symbol or symbol boundary in the center of the PRS block.

In implementations where averaging of the carrier phase measurements over time is used, it may not be the case that the measurements are exactly symmetrical in time with respect to the reference time for which carrier phase is defined. According to implementations, the signal-to-noise ratio of the carrier phase estimate can be improved by averaging across time even in the presence of a carrier frequency offset. Furthermore, by using a proper weighting of the measurements on either side of the reference time, it is possible to define an unbiased estimate of the carrier phase without the need to explicitly estimate the carrier frequency offset.

Similar issues exist when combining carrier phase measurements across frequency. As noted herein, the carrier phase of the TRP increases linearly with the subcarrier frequency due to the differential distance between the TRP and the reference cell of the UE or PRU. To combine carrier phase measurements from subcarriers other than the reference subcarrier m₀ and improve the signal-to noise ratio of the carrier phase estimate, the change in carrier phase due to the differential distance must be taken into account. Implementations discussed herein also provide for how to estimate the carrier frequency offset of the TRP relative to the serving cell of the UE or PRU or of the corresponding symbol-to-symbol phase rotation Δθ_{CFO}. Similarly, it does not require any knowledge or explicit estimate of the differential distance between the TRP and the reference cell of the UE or PRU, or of the subcarrier-to-subcarrier phase rotation Δθ_{d}.

In implementations, the order of averaging carrier phase estimates in time and frequency can be reversed. One advantage of averaging in frequency first is that carrier phase estimates are available for all symbol at the reference carrier frequency. This enables averaging of carrier phase measurements in the time domain such as in cases where the reference time is not the first or last symbol with PRS in the measurement time window.

By performing the described techniques, accuracy in device (e.g., UE) positioning in wireless communications systems can be increased. Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

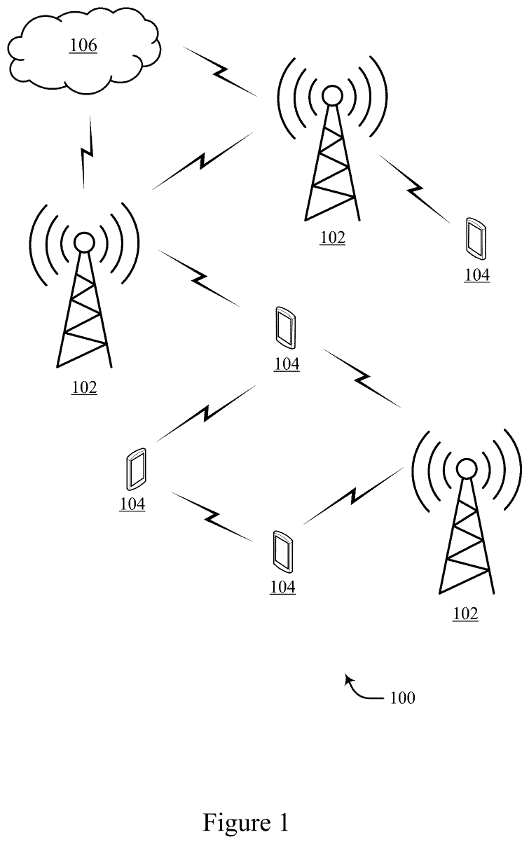

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or TRPs.

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHZ), FR3 (7.125 GHZ-24.25 GHZ), FR4 (52.6 GHz-114.25 GHZ), FR4a or FR4-1 (52.6 GHz-71 GHZ), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 KHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, a UE 104 receives (e.g., from a NE 102) signaling including one or more reference symbols of one or more TRPs. The UE transmits signaling including a carrier phase measurement generated based at least in part on a carrier phase of the one or more reference symbols relative to a carrier phase of a reference cell of the UE at a reference frequency and a reference time within a measurement time window.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

With reference to positioning requirements, NR positioning based on NR Uu signals and stand-alone (SA) architecture (e.g., beam-based transmissions) was first specified in Release 16. The targeted use cases also included commercial and regulatory (emergency services) scenarios as in Release 15. Example performance requirements are included in Table 1 below.

TABLE 1

| Positioning Error | Indoor | Outdoor |
|---|---|---|
| Horizontal Positioning | <3 m for 80% of UEs | <10 m for 80% of UEs |
| Vertical Positioning | <3 m for 80% of UEs | <3 m for 80% of UEs |

Currently 3GPP Release 17 positioning has defined the positioning performance requirements for commercial and IIoT use cases as follows in Table 2 below.

TABLE 2

| Positioning Error | Commercial | IIoT |
|---|---|---|
| Horizontal Positioning | (<1 m) for 90% | (<0.2 m) for 90% |
| | of UEs | of UEs; |
| Vertical Positioning | (<3 m) for 90% | (<1 m) for 90% |
| | of UEs | of UEs |
| Physical layer latency | (<10 ms) | (<10 ms) |
| for position estimation | | |
| of UE | | |
| End-to-End Latency | (<100 ms) | (<100 ms, in the order |
| for position estimation | | of 10 ms is desired) |
| of UE | | |

The supported UE positioning techniques are listed in Table 3 below.

TABLE 3

| | | | NG-RAN | |
|---|---|---|---|---|
| | UE- | UE-assisted, | node | |
| Method | based | LMF-based | assisted | SUPL |
| A-GNSS | Yes | Yes | No | Yes (UE-based |
| | | | | and UE-assisted) |
| OTDOA ^{Notes1, 2} | No | Yes | No | Yes (UE-assisted) |
| E-CID ^{Note 4} | No | Yes | Yes | Yes for E-UTRA |
| | | | | (UE-assisted) |
| Sensor | Yes | Yes | No | No |
| WLAN | Yes | Yes | No | Yes |
| Bluetooth | No | Yes | No | No |
| TBS ^{Note 5} | Yes | Yes | No | Yes (MBS) |
| DL-TDOA | Yes | Yes | No | No |
| DL-AoD | Yes | Yes | No | No |
| Multi-RTT | No | Yes | Yes | No |
| NR E-CID | No | Yes | FFS | No |
| UL-TDOA | No | No | Yes | No |
| UL-AoA | No | No | Yes | No |

^{Note1}:
This includes Terrestrial Beacon System (TBS) positioning based on PRS signals.
^{Note 2}:
In this version of the specification only observed time difference of arrival (OTDOA) based on LTE signals is supported.
^{Note 4}:
This includes Cell-ID for NR method.
^{Note 5}:
In this version of the specification is for TBS positioning based on metropolitan beacon system (MBS) signals.

Separate positioning techniques as indicated in Table 3 above can be currently configured and performed based on the requirements of the LMF and UE capabilities. The transmission of Uu (uplink and downlink) PRSs enable the UE to perform UE positioning-related measurements to enable the computation of a UE's absolute location estimate and are configured per transmission reception point (TRP), where a TRP may include a set of one or more beams.

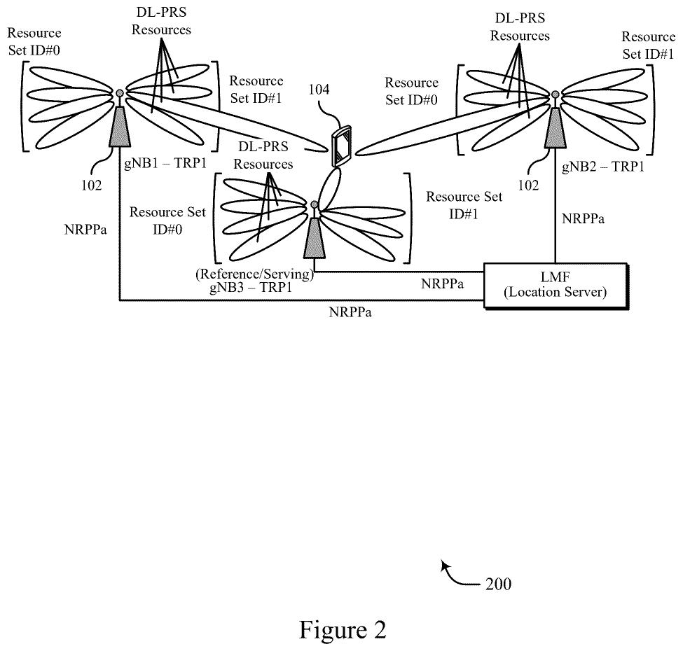

FIG. 2 illustrates an example of system 200 for NR beam-based positioning in accordance with aspects of the present disclosure. The system 200 illustrates a UE 104 and network entities 102 (e.g., gNBs). The PRS can be transmitted by different base stations (serving and neighboring) using narrow beams over FR1 and FR2 as illustrated in the example system 200, which is relatively different when compared to LTE where the PRS was transmitted across the whole cell. The PRS can be locally associated with a PRS Resource identifier (ID) and Resource Set ID for a base station (e.g., a TRP). Similarly, UE positioning measurements, such as RSTD and PRS reference signal received power (RSRP) measurements are made between beams (e.g., between a different pair of downlink (DL) PRS resources or DL PRS resource sets) as opposed to different cells as was the case in LTE. In addition, there are additional uplink positioning methods for the network to exploit in order to compute the target-UE's location.

Various RAT-dependent positioning techniques are supported in Release 16 and Release 17, such as DL-TDoA, DL-AOD, Multi-round trip time (RTT), enhanced cell-ID (E-CID)/NR E-CID, uplink (UL)-TDoA, and UL-AoA. The downlink time difference of arrival (DL-TDOA) positioning method makes use of the DL RSTD (and optionally DL PRS RSRP) of downlink signals received from multiple TPs, at the UE. The UE measures the DL RSTD (and optionally DL PRS RSRP) of the received signals using assistance data received from the positioning server, and the resulting measurements are used along with other configuration information to locate the UE in relation to the neighboring TPs.

The DL AoD positioning method makes use of the measured DL PRS RSRP of downlink signals received from multiple TPs, at the UE. The UE measures the DL PRS RSRP of the received signals using assistance data received from the positioning server, and the resulting measurements are used along with other configuration information to locate the UE in relation to the neighboring TPs. The Multi-RTT positioning method makes use of the UE Rx-Tx measurements and DL PRS RSRP of downlink signals received from multiple TRPs, measured by the UE and the measured gNB Rx-Tx measurements and UL sounding reference signal (SRS)-RSRP at multiple TRPs of uplink signals transmitted from UE.

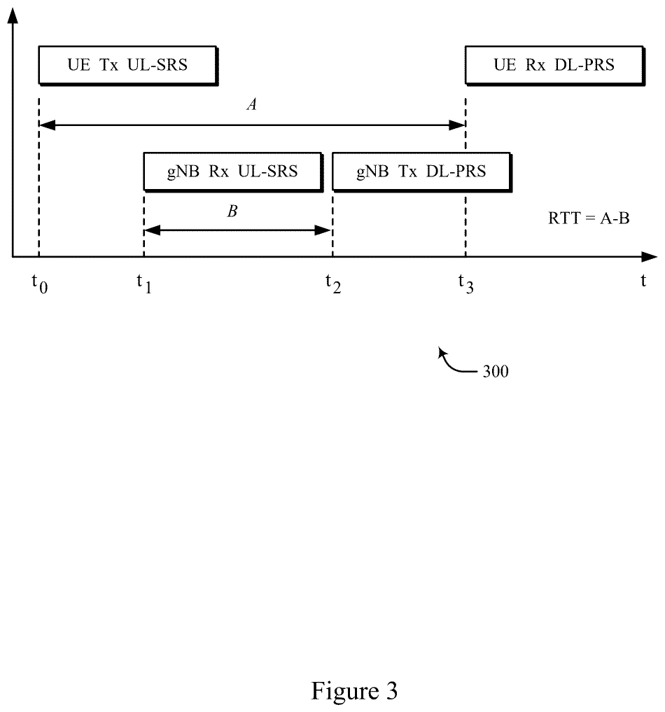

FIG. 3 illustrates an example 300 of a multi-cell RTT procedure as related to carrier phase positioning configuration in accordance with aspects of the present disclosure. The multi-RTT positioning technique makes use of the UE Rx-Tx measurements and DL PRS RSRP of downlink signals received from multiple TRPs, as measured by the UE and the measured gNB Rx-Tx measurements and uplink SRS RSRP (UL SRS-RSRP) at multiple TRPs of uplink signals transmitted from UE. The UE measures the UE Rx-Tx measurements (and optionally DL PRS RSRP of the received signals) using assistance data received from the positioning server (also referred to herein as the location server), and the TRPs the gNB Rx-Tx measurements (and optionally UL SRS-RSRP of the received signals) using assistance data received from the positioning server. The measurements are used to determine the RTT at the positioning server, which are used to estimate the location of the UE. In Release 16 the multi-RTT is only supported for UE-assisted and NG-RAN assisted positioning techniques as noted in Table 3.

For the NR enhanced cell ID (E-CID) positioning technique, the position of a UE is estimated with the knowledge of its serving ng-eNB, gNB, and cell, and is based on LTE signals. The information about the serving ng-eNB, gNB, and cell may be obtained by paging, registration, or other methods. The NR E-CID positioning refers to techniques which use additional UE measurements and/or NR radio resources and other measurements to improve the UE location estimate using NR signals. Although E-CID positioning may utilize some of the same measurements as the measurement control system in the radio resource control (RRC) protocol, the UE may not make additional measurements for the sole purpose of positioning (e.g., the positioning procedures do not supply a measurement configuration or measurement control message, and the UE reports the measurements that it has available rather than being required to take additional measurement actions).

The uplink time difference of arrival (UL-TDOA) positioning technique makes use of the UL-RTOA (and optionally UL SRS-RSRP) at multiple reception points (RPs) of uplink signals transmitted from UE. The RPs measure the UL-RTOA (and optionally UL SRS-RSRP) of the received signals using assistance data received from the positioning server, and the resulting measurements are used along with other configuration information to estimate the location of the UE.

The UL-AoA positioning technique makes use of the measured azimuth and the zenith of arrival at multiple RPs of uplink signals transmitted from UE. The RPs measure azimuth-AoA (A-AoA) and zenith-AoA (Z-AoA) of the received signals using assistance data received from the positioning server (also referred to herein as the location server), and the resulting measurements are used along with other configuration information to estimate the location of the UE.

Different downlink measurements used for RAT-dependent positioning techniques include including DL PRS-RSRP, DL RSTD and UE Rx-Tx Time Difference. The following measurement configurations may be used: 4 Pair of DL RSTD measurements can be performed per pair of cells, and each measurement is performed between a different pair of DL PRS Resources/Resource Sets with a single reference timing: 8 DL PRS RSRP measurements can be performed on different DL PRS resources from the same cell.

TABLE 4
Downlink measurements for downlink-based positioning techniques
DL PRS reference signal received power (DL PRS-RSRP)

| | |
|---|---|
| Definition | DL PRS-RSRP, is the linear average over the power contributions (in 6) |
| | of the resource elements that carry DL PRS reference signals configured |
| | for RSRP measurements within the considered measurement frequency |
| | bandwidth. |
| | For frequency range 1, the reference point for the DL PRS-RSRP shall be |
| | the antenna connector of the UE. For frequency range 2, DL PRS-RSRP |
| | shall be measured based on the combined signal from antenna elements |
| | corresponding to a given receiver branch. For frequency range 1 and 2, if |
| | receiver diversity is in use by the UE, the reported DL PRS-RSRP value |
| | shall not be lower than the corresponding DL PRS-RSRP of any of the |
| | individual receiver branches. |
| Applicable | RRC_CONNECTED intra-frequency, |
| for | RRC_CONNECTED inter-frequency |

DL reference signal time difference (DL RSTD)

| | |
|---|---|
| Definition | DL reference signal time difference (DL RSTD) is the DL relative timing |
| | difference between the positioning node j and the reference positioning |
| | node i, defined as T_{SubframeRxj} − T_{SubframeRxi}, |
| | Where: |
| | T_{SubframeRxj} is the time when the UE receives the start of one subframe |
| | from positioning node j. |
| | T_{SubframeRxi} is the time when the UE receives the corresponding start of |
| | one subframe from positioning node i that is closest in time to the |
| | subframe received from positioning node j. |
| | Multiple DL PRS resources can be used to determine the start of one |
| | subframe from a positioning node. |
| | For frequency range 1, the reference point for the DL RSTD shall be the |
| | antenna connector of the UE. For frequency range 2, the reference point |
| | for the DL RSTD shall be the antenna of the UE. |
| Applicable | RRC_CONNECTED intra-frequency |
| for | RRC_CONNECTED inter-frequency |

UE Rx − Tx time difference

| | |
|---|---|
| Definition | The UE Rx − Tx time difference is defined as T_{UE-RX} − T_{UE-TX} |
| | Where: |
| | T_{UE-RX} is the UE received timing of downlink subframe #i from a |
| | positioning node, defined by the first detected path in time. |
| | T_{UE-TX} is the UE transmit timing of uplink subframe #j that is closest in |
| | time to the subframe #i received from the positioning node. |
| | Multiple DL PRS resources can be used to determine the start of one |
| | subframe of the first arrival path of the positioning node. |
| | For frequency range 1, the reference point for T_{UE-RX} measurement shall |
| | be the Rx antenna connector of the UE and the reference point for T_{UE-TX} |
| | measurement shall be the Tx antenna connector of the UE. For frequency |
| | range 2, the reference point for T_{UE-RX} measurement shall be the Rx |
| | antenna of the UE and the reference point for T_{UE-TX} measurement shall |
| | be the Tx antenna of the UE. |
| Applicable | RRC_CONNECTED intra-frequency |
| for | RRC_CONNECTED inter-frequency |

DL PRS RSRPP (Reference Signal Received Path Power)

| | |
|---|---|
| Definition | DL PRS reference signal received path power (DL PRS-RSRPP), is |
| | defined as the power of the linear average of the channel response at the |
| | i-th path delay of the resource elements that carry DL PRS signal |
| | configured for the measurement, where DL PRS-RSRPP for the 1st path |
| | delay is the power contribution corresponding to the first detected path in |
| | time. |
| | For frequency range 1, the reference point for the DL PRS-RSRPP shall |
| | be the antenna connector of the UE. For frequency range 2, DL PRS- |
| | RSRPP shall be measured based on the combined signal from antenna |
| | elements corresponding to a given receiver branch. |
| Applicable for | RRC_CONNECTED |
| | RRC_INACTIVE |

The carrier frequency tolerance for the base station is defined in 3GPP Technical Specification (TS) 38.104 and is given in the following two tables:

TABLE 6.5.1.2-1
Frequency error minimum requirement

| Base Station (BS) | | |
|---|---|---|
| class | Accuracy | |
| Wide Area BS | ±0.05 | ppm |
| Medium Range BS | ±0.1 | ppm |
| Local Area BS | ±0.1 | ppm |

TABLE 9.6.1.3-1
Over The Air (OTA) frequency error minimum requirement

| BS class | Accuracy | |
|---|---|---|
| Wide Area BS | ±0.05 | ppm |
| Medium Range BS | ±0.1 | ppm |
| Local Area BS | ±0.1 | ppm |

The carrier frequency tolerance for the UE is defined in TS 38.101-1 for FR1. In section 6.4.1 of TS 38.101-1, the requirement is specified that the UE basic measurement interval of modulated carrier frequency is 1 UL slot. The mean value of basic measurements of UE modulated carrier frequency shall be accurate to within ±0.1 parts per million (PPM) observed over a period of 1 ms of cumulated measurement intervals compared to the carrier frequency received from the NR Node B.

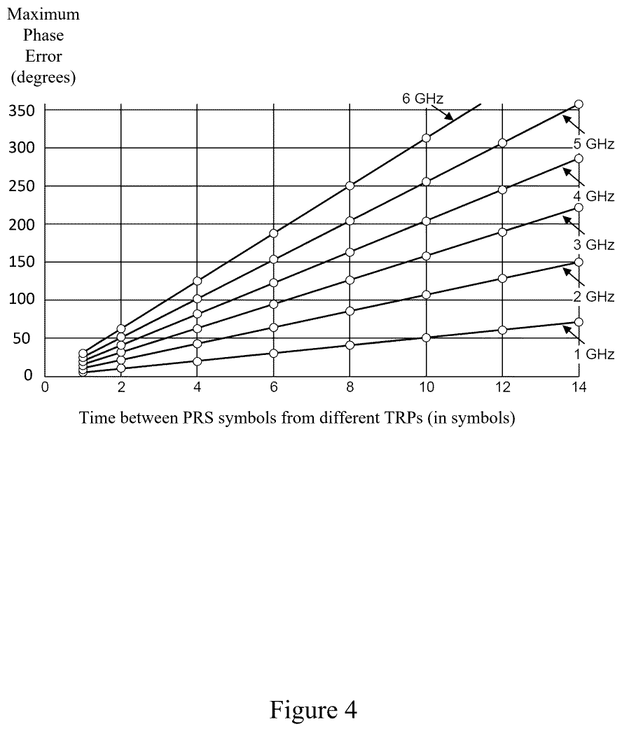

FIG. 4 illustrates maximum phase error vs. time between DL-PRS symbol from different TRPs (in symbols) in accordance with aspects of the present disclosure. The expected value of the carrier phase measurement error can be computed as

$$n ( {Δφ}_{m , UE}^{TX} - {Δφ}_{m , PRU}^{TX} )$$

where

$${Δφ}_{m , UE}^{TX} and {Δφ}_{m , PRU}^{TX}$$

denote the phase rotation over one symbol of the of the carrier of the m-th TRP relative to the UE and the PRU, respectively, and n is the difference in the symbol indices of the two DL-PRS symbols. The maximum phase error vs. time between DL-PRS symbol from different TRPs (in symbols) is shown in FIG. 4.

In one proposal, the LMF is enabled to correct carrier phase difference measurement errors due to carrier frequency offsets, the carrier frequency offset can be measured by both the UE and the PRU for each TRP for which measurements are taken, and these carrier frequency offsets can be reported to the LMF. Additionally, if either carrier phase measurements or carrier phase difference measurements are reported by the UE and the PRU, a number of symbols separating the measured DL-PRS for any two TRPs can be reported to the LMF.

In implementations the errors due to the carrier frequency offsets can be removed by referring the carrier phase measurements at the UE and the PRU to a common reference time. For instance, a common reference time can be defined and refer the DL-PRS carrier phase measurements to the reference time by subtracting the phase rotation due to the carrier frequency offset in the time interval between the DL-PRS and the reference time from the carrier phase measurement. Further, the referred carrier phase difference can be defined as the difference between the referred carrier phase measurements. Still further, the same common reference time can be defined for the UE and the PRU.

Implementations provide for definition of average carrier phase measurement. In some scenarios, a common reference time be defined and carrier phase measurements can be referred to the common reference time by removing the phase rotation of the carrier phase that occurs due to carrier frequency offset in the interval between the reference time and the time at which the carrier phase is measured. However, while the definition of the common reference time describes how to compute the carrier phase using carrier phase measurements taken at any time, it does not strictly define the carrier phase of reference symbols transmitted by a TRP and received by a UE or PRU. Even if a common reference time is not defined in the specification and carrier phase measurements are not referred to this common reference time, it is still necessary to precisely define carrier phase and carrier phase difference for a time measurement window in the presence of a carrier frequency offset, since a non-zero carrier frequency offset will always be present in any real deployment. It should be noted that in the 3GPP specification, carrier phase is defined at the RF frequency of a center subcarrier of the downlink PFL/UL SRS transmission bandwidth, so that it is already the case that a reference frequency is defined for carrier phase measurements.

In aspects of the present disclosure, solutions are detailed for carrier phase positioning including reference symbol carrier phase and reference symbol carrier phase difference positioning. One issue addressed herein is how to correct for carrier frequency offsets between the TRPs and the receivers of the UE's and the PRUs. The carrier phase of a TRP relative to a UE or PRU can be defined as the carrier phase of reference symbols transmitted by the TRP relative to the carrier phase of the reference cell (e.g., the serving cell) of the UE or PRU at a specified frequency and a specified reference time within the measurement time window. The carrier phase difference of two TRPs relative to a UE or PRU can be defined as the difference of the carrier phase of the first TRP and the carrier of the second TRP, where the carrier phase of each TRP is measured relative to the carrier phase of the reference cell (e.g., the serving cell) at a specified frequency and a specified reference time within the measurement time window.

In implementations a specified reference time can be determined by the location server (e.g., LMF) and signaled to the UE and the PRU. The LMF may use the LTE Positioning Protocol (LPP) ProvideAssistanceData or LPP ProvideLocationInformation message to signal the specified reference time. Alternatively or additionally, the specified reference time can be determined by default as the center of the measurement time window or other location within the measurement time window. The default reference time may be pre-configured or configured by the LMF.

In implementations the average carrier phase and the average carrier phase difference can be defined. The average carrier phase for a TRP can be defined as the average of carrier phase measurements taken over a measurement time window, or a portion of a measurement time window. Where the carrier frequency offset is constant over the averaging period, the expected value of the average carrier phase can be equal to the carrier phase at the center of the averaging window. The average carrier phase difference for two TRPs can then be defined as the difference between the average carrier phases for the first and second TRPs, where the average carrier phase for each of the two TRPs can be measured over a measurement time window. Where the carrier frequency offsets for the two TRPs is constant over the averaging period, the average carrier phase difference can be equal to the difference of the carrier phases for the TRPs at the center of the averaging window.

Referring carrier phase measurements to a common reference time can involve that the carrier frequency offset be estimated for each TRP so that the carrier phase rotation in the interval between the reference time and the measurement can be removed from the measurement. Further, by averaging carrier phase measurements symmetrically about the reference time, the resulting average carrier phase can be equal to the carrier phase without the need to explicitly estimate the carrier frequency offset. Alternatively or additionally, by properly weighting carrier phase measurements taken on either side of the reference time but not symmetrically located about the reference time, the resulting average of this weighted carrier phase measurement can be equal to the carrier phase at the reference time and this weighted estimate may not require explicit estimation of the carrier frequency offset. The latter implementation is discussed in more detail below.

Where carrier phase averaging is implemented, the carrier phase measurements are not to wrap relative to the carrier phase at the reference time. For instance, if the symbol-to-symbol phase rotation Δθ_{CFO} due to the carrier frequency offset is positive, the carrier phase measurements are to be interpreted so that if k>0, then \hat{θ}ₙ_{ₒ}_{+k,m}_{ₒ}≥\hat{θ}ₙ_{ₒ}_{,m}_{ₒ} and \hat{θ}ₙ_{ₒ}_{-k,m}_{ₒ}≤\hat{θ}ₙ_{ₒ}_{,m}_{ₒ}. For example, the carrier phase measurements can be interpreted where the symbol-to-symbol phase rotation is less than π radians.

Implementations describe average carrier phase measurement across time. For instance, to minimize the impact of carrier frequency offset on carrier phase measurements, it has been proposed that a small measurement time window consisting of a few positioning reference symbols (PRS) be configured for carrier phase and carrier phase difference measurements. This approach may be acceptable when the signal-to-interference and noise ratio (SINR) of the positioning reference symbols is high. However, averaging carrier phase measurements taken over a larger measurement time window may be important when the signal-to-noise ratio of the received PRS is low.

In the case that averaging of the carrier phase measurements over time is used, the measurements may not be symmetrical in time with respect to the reference time for which carrier phase is defined. For instance, carrier phase measurements can be taken on both sides of the reference time. Let θ_{n,m} denote the carrier phase of a TRP with respect to the reference cell of the UE or the PRU for the n-th symbol and the m-th subcarrier. Let the reference symbol and subcarrier for defining carrier phase be given by n₀ and m₀, respectively, so that θₙ_{ₒ}_{,m}_{ₒ} denotes the carrier phase at the reference time and frequency. Let Δθ_{CFO} denote the symbol-to-symbol variation of the carrier phase due to the carrier frequency offset of the TRP relative to the reference cell. Similarly, let Δθ_{d} denote the subcarrier-to-subcarrier progression of the carrier phase due to the differential distance between the TRP and the reference cell of the TRP or PRU.

In implementations the PRS symbols for each TRP follow a comb pattern so that every K-th symbol in time and frequency contains a PRS symbol for any given TRP. Let the offsets kⱼ for 1≤j≤J denote the time offset of symbols, relative to the carrier phase reference time n₀, of PRS symbols for a given TRP where kⱼ>0 for all 1≤j≤J. On a resource element grid, all of these symbols with PRS are to the right of the carrier phase reference time n₀. Similarly, let lₘ for 1≤m≤M denote the time offset of symbols with PRS to left of the carrier phase reference time n₀, where lₘ≥0 for all 1≤j≤M. From the description above, we have that

$${θ}_{{n}_{0} + {k}_{j} , {m}_{0}} = {θ}_{{n}_{0} , {m}_{0}} + {k}_{j} \cdot {Δθ}_{CFO} \\ and \\ {θ}_{{n}_{0} - {l}_{m} , {m}_{0}} = {θ}_{{n}_{0} , {m}_{0}} - {l}_{m} \cdot {Δθ}_{CFO}$$

Let \hat{θ}_{n,m} denote an unbiased estimate of θ_{n,m} with the property that E(\hat{θ}_{n,m})=θ_{n,m}. The estimate \hat{θ}_{n,m} can be based on a single PRS symbol. With these definitions,

$$\begin{matrix}E ( {\sum }_{j = 1}^{J} {\hat{θ}}_{{n}_{0} + {k}_{j} , {m}_{0}} ) = J \cdot {θ}_{{n}_{0} , {m}_{0}} + {Δθ}_{CFO} \cdot {\sum }_{j = 1}^{J} {k}_{j} \\ and & ( 1 ) \\ E ( {\sum }_{m = 1}^{M} {\hat{θ}}_{{n}_{0} - {l}_{m} , {m}_{0}} ) = M \cdot {θ}_{{n}_{0} , {m}_{0}} - {Δθ}_{CFO} \cdot {\sum }_{m = 1}^{M} {l}_{m} . & ( 2 )\end{matrix}$$

The expression (1) can be rewritten as

$$\frac{{\sum }_{m = 1}^{M} {l}_{m}}{{\sum }_{j = 1}^{J} {k}_{j}} \cdot E ( {\sum }_{j = 1}^{J} {\hat{θ}}_{{n}_{0} + {k}_{j} , {m}_{0}} ) = \frac{{\sum }_{m = 1}^{M} {l}_{m}}{{\sum }_{j = 1}^{J} {k}_{j}} \cdot J \cdot {θ}_{{n}_{0} , {m}_{0}} + {Δθ}_{CFO} \cdot {\sum }_{m = 1}^{M} {l}_{m} . \qquad ( 3 )$$

Adding (2) and (3) yields

$$E ( {\sum }_{m = 1}^{M} {\hat{θ}}_{{n}_{0} - {l}_{m} , {m}_{0}} ) = \frac{{\sum }_{m = 1}^{M} {l}_{m}}{{\sum }_{j = 1}^{J} {k}_{j}} \cdot E ( {\sum }_{j = 1}^{J} {\hat{θ}}_{{n}_{0} + {k}_{j} , {m}_{0}} ) = M \cdot {θ}_{{n}_{0} , {m}_{0}} + \frac{{\sum }_{m = 1}^{M} {l}_{m}}{{\sum }_{j = 1}^{J} {k}_{j}} \cdot J \cdot {θ}_{{n}_{0} , {m}_{0}}$$

so that

$${θ}_{{n}_{0} , {m}_{0}} = \frac{E ( {\sum }_{m = 1}^{M} {\hat{θ}}_{{n}_{0} - {l}_{m} , {m}_{0}} ) = \frac{{\sum }_{m = 1}^{M} {l}_{m}}{{\sum }_{j = 1}^{J} {k}_{j}} \cdot E ( {\sum }_{j = 1}^{J} {\hat{θ}}_{{n}_{0} + {k}_{j} , {m}_{0}} )}{M + J \cdot \frac{{\sum }_{m = 1}^{M} {l}_{m}}{{\sum }_{j = 1}^{J} {k}_{j}}}$$

and thus θₙ_{ₒ}_{,m}_{ₒ} can be estimated from all of the one or more reference symbols on a given subcarrier frequency as

$${\overline{θ}}_{{n}_{0} , {m}_{0}} = \frac{{\sum }_{m = 1}^{M} {\hat{θ}}_{{n}_{0} - {l}_{m} , {m}_{0}} + \frac{{\sum }_{m = 1}^{M} {l}_{m}}{{\sum }_{j = 1}^{J} {k}_{j}} \cdot {\sum }_{j = 1}^{J} {\hat{θ}}_{{n}_{0} + {k}_{j} , {m}_{0}}}{M + J \cdot \frac{{\sum }_{m = 1}^{M} {l}_{m}}{{\sum }_{j = 1}^{J} {k}_{j}}} . \qquad ( 4 )$$

For this expression to be defined and non-zero, both J and M are to be greater than 0, and this implies that measurements are taken on both sides of the reference time. Thus, the reference time is not the first or last symbol containing PRS within the slot. These can be defined as specified conditions of the reference time within the slot. If multiple slots have PRS, then the reference time is not be the first symbol with PRS in the first slot or the last symbol with PRS in the last slot.

In the special case in which

$${\sum }_{m = 1}^{M} {l}_{m} = {\sum }_{j = 1}^{J} {k}_{j} ,$$

there is

$${\overline{θ}}_{{n}_{0} , {m}_{0}} = \frac{{\sum }_{m = 1}^{M} {\hat{θ}}_{{n}_{0} - {l}_{m} , {m}_{0}} + {\sum }_{j = 1}^{J} {\hat{θ}}_{{n}_{0} + {k}_{j} , {m}_{0}}}{M + J} ,$$

so that the signal-to-noise ratio of the carrier phase estimate is improved by the number of measurements M+J without the need to explicitly estimate the carrier frequency offset.

Implementations also provide for average carrier phase measurement across frequency. For instance, the signal-to-noise ratio of the carrier phase estimate can be improved by averaging across time even in the presence of a carrier frequency offset. Furthermore, by using a proper weighting of the measurements on either side of the reference time, it is possible to define an unbiased estimate of the carrier phase without the need to explicitly estimate the carrier frequency offset.

A similar issue exists when combining carrier phase measurements across frequency. As noted above, the carrier phase of the TRP increases linearly with the subcarrier frequency due to the differential distance between the TRP and the reference cell of the UE or PRU. In order to combine carrier phase measurements from subcarriers other than the reference subcarrier m₀ and improve the signal-to noise ratio of the carrier phase estimate, the change in carrier phase due to the differential distance is to be considered. As above, let Δθ_{d} denote the subcarrier-to-subcarrier progression of the carrier phase due to the differential distance between the TRP and the reference cell of the TRP or PRU. Then:

$${θ}_{{n}_{0} , {m}_{0} + p} = {θ}_{{n}_{0} , {m}_{0}} + p \cdot {Δθ}_{d} \\ and \\ {θ}_{{n}_{0} {m}_{0} - q} = {θ}_{{n}_{0} , {m}_{0}} - q \cdot {Δθ}_{d} .$$

Here it can be assumed that carrier phase estimates are available for all subcarriers given that the carrier phase can be estimated for any time index nₒ regardless of the subcarrier frequency by averaging in the time domain as above. Let P denote the number of subcarriers higher than mₒ and Q denote the number of subcarriers lower than mₒ. Following the same approach as in (4) above, the reference carrier phase θₙ_{ₒ}_{,m}_{ₒ} can be estimated as

$${\overline{\overline{θ}}}_{{n}_{0} , {m}_{0}} = \frac{{\sum }_{q = 1}^{Q} {\hat{θ}}_{{n}_{0} , {m}_{0} - q} + \frac{{\sum }_{q = 1}^{Q} q}{{\sum }_{p = 0}^{P} p} \cdot {\sum }_{p = 0}^{P} {\hat{θ}}_{{n}_{0} , {m}_{0} + p}}{P + Q \cdot \frac{{\sum }_{q = 1}^{Q} q}{{\sum }_{p = 0}^{P} p}} = \frac{{\sum }_{q = 1}^{Q} {\hat{θ}}_{{n}_{0} , {m}_{0} - q} + \frac{Q ( Q + 1 )}{P ( P + 1 )} \cdot {\sum }_{p = 0}^{P} {\hat{θ}}_{{n}_{0} , {m}_{0} + p}}{P + Q \cdot \frac{Q ( Q + 1 )}{P ( P + 1 )}} . \qquad ( 5 )$$

In a special case in which P=Q,

$${\overline{\overline{θ}}}_{{n}_{0} , {m}_{0}} = \frac{{\sum }_{q = 1}^{Q} {\hat{θ}}_{{n}_{0} , {m}_{0} - q} + {\sum }_{p = 0}^{P} {\hat{θ}}_{{n}_{0} , {m}_{0} + p}}{2 P}$$

Further, if the carrier phase estimate \hat{θ}_{n,m} based on a single PRS symbol is replaced with the time averaged carrier phase estimate θ̅_{n,m} in (4),

$${\overline{\overline{θ}}}_{{n}_{0} , {m}_{0}} = \frac{{\sum }_{q = 1}^{Q} {\overline{θ}}_{{n}_{0} , {m}_{0} - q} + \frac{Q ( Q + 1 )}{P ( P + 1 )} \cdot {\sum }_{p = 0}^{P} {\overline{θ}}_{{n}_{0} , {m}_{0} + p}}{+ Q \cdot \frac{Q ( Q + 1 )}{P ( P + 1 )}} \qquad ( 6 )$$

which is based on all of the PRS received from the TRP within the given measurement time window.

It can be noted that this estimate (6) does not require any explicit estimate of the carrier frequency offset of the TRP relative to the serving cell of the UE or PRU or of the corresponding symbol-to-symbol phase rotation Δθ_{CFO}. Similarly, it does not require any knowledge or explicit estimate of the differential distance between the TRP and the reference cell of the UE or TRP, or of the subcarrier-to-subcarrier phase rotation Δθ_{d}.

Implementations also provide for the order of averaging over time and frequency. For instance, in the analysis above, averaging in the time domain can be performed prior to averaging in the frequency domain. This can occur where at least two PRS from the TRP in the same subcarrier, with at least one on either side of the reference time. If this is not the case, then averaging can be performed first in the frequency domain since the reference subcarrier is typically in the middle of the positioning frequency layer so that there are PRS from the TRP on either side of the reference carrier. A positioning frequency layer, for instance, includes multiple PRS resource sets and each PRS resource set defines a collection of PRS resources which can be configured with common parameters. If averaging is performed in the frequency domain first, then one requirement is that the reference time not be either the first or last symbol containing PRS in the measurement time window.

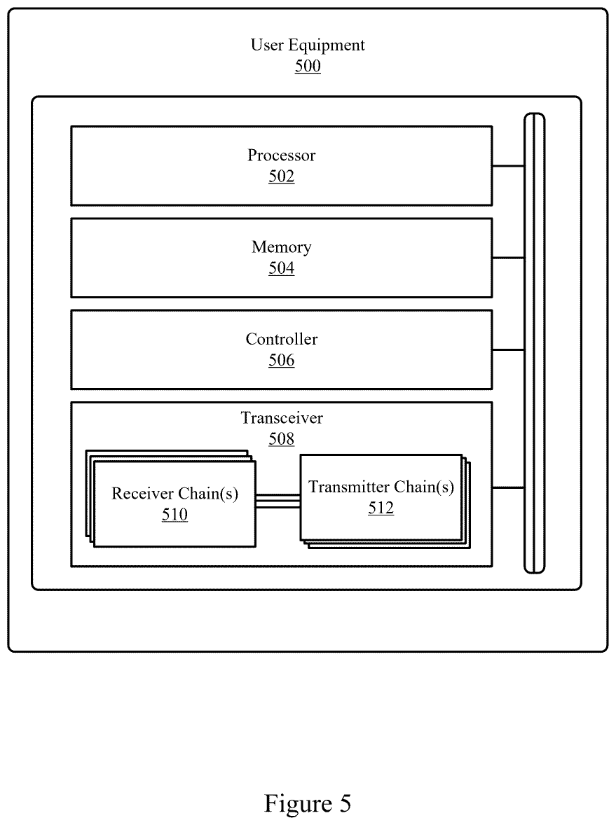

FIG. 5 illustrates an example of a UE 500 in accordance with aspects of the present disclosure. The UE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a CPU, an ASIC, an FPGA, or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the UE 500 to perform various functions of the present disclosure.

The memory 504 may include volatile or non-volatile memory. The memory 504 may store computer-readable, computer-executable code including instructions when executed by the processor 502 cause the UE 500 to perform various functions described herein. The code may be stored in a non-transitory computer-readable medium such as the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the UE 500 to perform one or more of the functions described herein (e.g., executing, by the processor 502, instructions stored in the memory 504). For example, the processor 502 may support wireless communication at the UE 500 in accordance with examples as disclosed herein. The UE 500 may be configured to or operable to support a means for receiving signaling including one or more reference symbols of one or more TRPs; and transmitting signaling including a carrier phase measurement generated based at least in part on a carrier phase of the one or more reference symbols relative to a carrier phase of a reference cell of the UE at a reference frequency and a reference time within a measurement time window.

Additionally, the UE 500 may be configured to support any one or combination of where the reference frequency includes a center frequency of a positioning frequency layer; the reference time includes a center of the measurement time window; the reference time is defined according to one or more combinations of symbol index, slot number, slot offset, system frame number, subframe number, UTC time, or GNSS time; the one or more reference symbols include one or more downlink PRS; further including estimating the carrier phase as a weighted combination of phase estimates of the one or more reference symbols; the phase estimates of the one or more reference symbols are generated based at least in part on the reference frequency and the reference time; further including generating the carrier phase measurement based at least in part on a carrier phase difference of a first carrier phase of a first TRP and a second carrier phase of a second TRP of the one or more TRPs; further including determining the first carrier phase and the second carrier phase relative to the carrier phase of the reference cell; the UE is associated with a PRU; further including receiving third signaling including one or more of the reference frequency or the reference time.

Additionally, or alternatively, the UE 500 may support at least one memory (e.g., the memory 504) and at least one processor (e.g., the processor 502) coupled with the at least one memory and configured to cause the UE to receive signaling including one or more reference symbols of one or more TRPs; and transmit signaling including a carrier phase measurement generated based at least in part on a carrier phase of the one or more reference symbols relative to a carrier phase of a reference cell of the UE at a reference frequency and a reference time within a measurement time window.

Additionally, the UE 500 may be configured to support any one or combination of where the reference frequency includes a center frequency of a positioning frequency layer; the reference time includes a center of the measurement time window; the reference time is defined according to one or more combinations of symbol index, slot number, slot offset, system frame number, subframe number, UTC time, or GNSS time; the one or more reference symbols include one or more downlink PRS; the at least one processor is configured to cause the UE to estimate the carrier phase as a weighted combination of phase estimates of the one or more reference symbols; the phase estimates of the one or more reference symbols are generated based at least in part on the reference frequency and the reference time; the at least one processor is configured to cause the UE to generate the carrier phase measurement based at least in part on a carrier phase difference of a first carrier phase of a first TRP and a second carrier phase of a second TRP of the one or more TRPs; the at least one processor is configured to cause the UE to determine the first carrier phase and the second carrier phase relative to the carrier phase of the reference cell; the UE is associated with a PRU; the at least one processor is configured to cause the UE to receive third signaling including one or more of the reference frequency or the reference time.

The controller 506 may manage input and output signals for the UE 500. The controller 506 may also manage peripherals not integrated into the UE 500. In some implementations, the controller 506 may utilize an operating system such as iOS®, ANDROID®, WINDOWS®, or other operating systems. In some implementations, the controller 506 may be implemented as part of the processor 502.

In some implementations, the UE 500 may include at least one transceiver 508. In some other implementations, the UE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas to receive a signal over the air or wireless medium. The receiver chain 510 may include at least one amplifier (e.g., a low-noise amplifier (LNA)) configured to amplify the received signal. The receiver chain 510 may include at least one demodulator configured to demodulate the receive signal and obtain the transmitted data by reversing the modulation technique applied during transmission of the signal. The receiver chain 510 may include at least one decoder for decoding the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

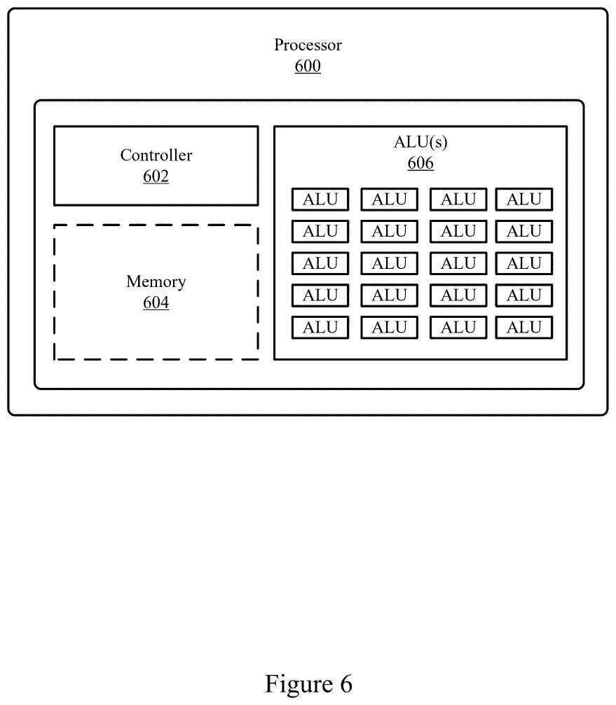

FIG. 6 illustrates an example of a processor 600 in accordance with aspects of the present disclosure. The processor 600 may be an example of a processor configured to perform various operations in accordance with examples as described herein. The processor 600 may include a controller 602 configured to perform various operations in accordance with examples as described herein. The processor 600 may optionally include at least one memory 604, which may be, for example, an L1/L2/L3 cache. Additionally, or alternatively, the processor 600 may optionally include one or more arithmetic-logic units (ALUs) 606. One or more of these components may be in electronic communication or otherwise coupled (e.g., operatively, communicatively, functionally, electronically, electrically) via one or more interfaces (e.g., buses).

The processor 600 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 600) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 602 may be configured to manage and coordinate various operations (e.g., signaling, receiving, obtaining, retrieving, transmitting, outputting, forwarding, storing, determining, identifying, accessing, writing, reading) of the processor 600 to cause the processor 600 to support various operations in accordance with examples as described herein. For example, the controller 602 may operate as a control unit of the processor 600, generating control signals that manage the operation of various components of the processor 600. These control signals include enabling or disabling functional units, selecting data paths, initiating memory access, and coordinating timing of operations.

The controller 602 may be configured to fetch (e.g., obtain, retrieve, receive) instructions from the memory 604 and determine subsequent instruction(s) to be executed to cause the processor 600 to support various operations in accordance with examples as described herein. The controller 602 may be configured to track memory addresses of instructions associated with the memory 604. The controller 602 may be configured to decode instructions to determine the operation to be performed and the operands involved. For example, the controller 602 may be configured to interpret the instruction and determine control signals to be output to other components of the processor 600 to cause the processor 600 to support various operations in accordance with examples as described herein. Additionally, or alternatively, the controller 602 may be configured to manage flow of data within the processor 600. The controller 602 may be configured to control transfer of data between registers, ALUs 606, and other functional units of the processor 600.

The memory 604 may include one or more caches (e.g., memory local to or included in the processor 600 or other memory, such as RAM, ROM, DRAM, SDRAM, SRAM, MRAM, flash memory, etc. In some implementations, the memory 604 may reside within or on a processor chipset (e.g., local to the processor 600). In some other implementations, the memory 604 may reside external to the processor chipset (e.g., remote to the processor 600).

The memory 604 may store computer-readable, computer-executable code including instructions that, when executed by the processor 600, cause the processor 600 to perform various functions described herein. The code may be stored in a non-transitory computer-readable medium such as system memory or another type of memory. The controller 602 and/or the processor 600 may be configured to execute computer-readable instructions stored in the memory 604 to cause the processor 600 to perform various functions. For example, the processor 600 and/or the controller 602 may be coupled with or to the memory 604, the processor 600, and the controller 602, and may be configured to perform various functions described herein. In some examples, the processor 600 may include multiple processors and the memory 604 may include multiple memories. One or more of the multiple processors may be coupled with one or more of the multiple memories, which may, individually or collectively, be configured to perform various functions herein.

The one or more ALUs 606 may be configured to support various operations in accordance with examples as described herein. In some implementations, the one or more ALUs 606 may reside within or on a processor chipset (e.g., the processor 600). In some other implementations, the one or more ALUs 606 may reside external to the processor chipset (e.g., the processor 600). One or more ALUs 606 may perform one or more computations such as addition, subtraction, multiplication, and division on data. For example, one or more ALUs 606 may receive input operands and an operation code, which determines an operation to be executed. One or more ALUs 606 may be configured with a variety of logical and arithmetic circuits, including adders, subtractors, shifters, and logic gates, to process and manipulate the data according to the operation. Additionally, or alternatively, the one or more ALUs 606 may support logical operations such as AND, OR, exclusive-OR (XOR), not-OR (NOR), and not-AND (NAND), enabling the one or more ALUs 606 to handle conditional operations, comparisons, and bitwise operations.

The processor 600 may support wireless communication in accordance with examples as disclosed herein. The processor 600 may be configured to or operable to support at least one controller (e.g., the controller 602) coupled with at least one memory (e.g., the memory 604) and configured to cause the processor to receive signaling including one or more reference symbols of one or more TRPs; and transmit signaling including a carrier phase measurement generated based at least in part on a carrier phase of the one or more reference symbols relative to a carrier phase of a reference cell of a UE at a reference frequency and a reference time within a measurement time window.

Additionally, the processor 600 may be configured to or operable to support any one or combination of where the reference frequency includes a center frequency of a positioning frequency layer; the reference time includes a center of the measurement time window; the reference time is defined according to one or more combinations of symbol index, slot number, slot offset, system frame number, subframe number, UTC time, or GNSS time; the one or more reference symbols include one or more downlink PRS; the at least one controller is configured to cause the processor to estimate the carrier phase as a weighted combination of phase estimates of the one or more reference symbols; the phase estimates of the one or more reference symbols are generated based at least in part on the reference frequency and the reference time; the at least one controller is configured to cause the processor to generate the carrier phase measurement based at least in part on a carrier phase difference of a first carrier phase of a first TRP and a second carrier phase of a second TRP of the one or more TRPs; the at least one controller is configured to cause the processor to determine the first carrier phase and the second carrier phase relative to the carrier phase of the reference cell; the UE is associated with a PRU; the at least one controller is configured to cause the processor to receive third signaling including one or more of the reference frequency or the reference time.

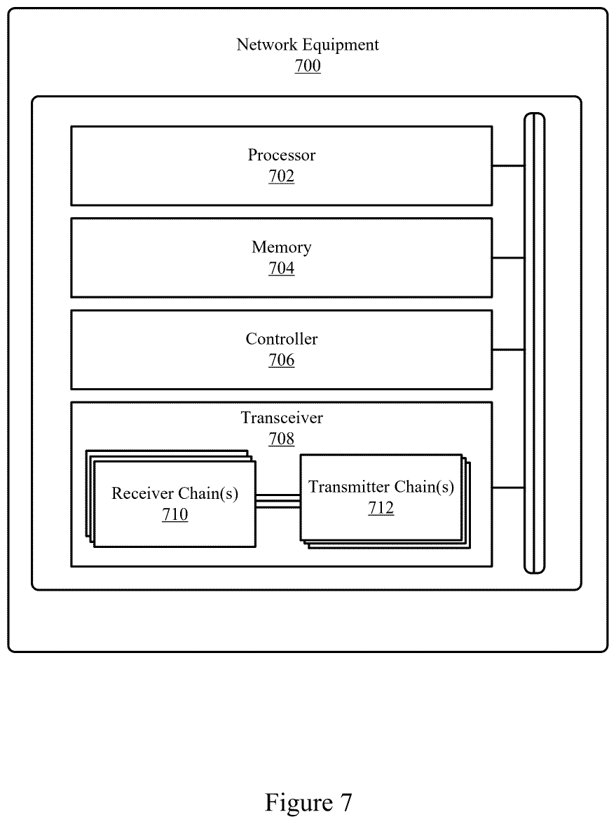

FIG. 7 illustrates an example of a NE 700 in accordance with aspects of the present disclosure. The NE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the NE 700 to perform various functions of the present disclosure.

The memory 704 may include volatile or non-volatile memory. The memory 704 may store computer-readable, computer-executable code including instructions when executed by the processor 702 cause the NE 700 to perform various functions described herein. The code may be stored in a non-transitory computer-readable medium such as the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the NE 700 to perform one or more of the functions described herein (e.g., executing, by the processor 702, instructions stored in the memory 704). For example, the processor 702 may support wireless communication at the NE 700 in accordance with examples as disclosed herein. The NE 700 may be configured to or operable to support a means for transmitting signaling including configuration for generating carrier phase measurement at a UE based at least in part on a carrier phase of one or more reference symbols relative to a carrier phase of a reference cell of the UE at a reference frequency and a reference time within a measurement time window.

Additionally, the NE 700 may be configured to or operable to support any one or combination of wherein one or more of: the reference frequency includes a center frequency of a positioning frequency layer; or the reference time includes a center of the measurement time window; further including: receiving, from the UE, signaling including a carrier phase measurement; and estimating a position of the UE based at least in part on the carrier phase measurement.

Additionally, or alternatively, the NE 700 may support at least one memory (e.g., the memory 704) and at least one processor (e.g., the processor 702) coupled with the at least one memory and configured to cause the NE to transmit signaling including configuration for generating carrier phase measurement at a UE based at least in part on a carrier phase of one or more reference symbols relative to a carrier phase of a reference cell of the UE at a reference frequency and a reference time within a measurement time window.

Additionally, the NE 700 may be configured to support any one or combination of one or more of: the reference frequency includes a center frequency of a positioning frequency layer; or the reference time includes a center of the measurement time window; the at least one processor is configured to cause the network equipment to: receive, from the UE, signaling including a carrier phase measurement; and estimate a position of the UE based at least in part on the carrier phase measurement.

The controller 706 may manage input and output signals for the NE 700. The controller 706 may also manage peripherals not integrated into the NE 700. In some implementations, the controller 706 may utilize an operating system such as iOS®, ANDROID®, WINDOWS®, or other operating systems. In some implementations, the controller 706 may be implemented as part of the processor 702.

In some implementations, the NE 700 may include at least one transceiver 708. In some other implementations, the NE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas to receive a signal over the air or wireless medium. The receiver chain 710 may include at least one amplifier (e.g., a low-noise amplifier (LNA)) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

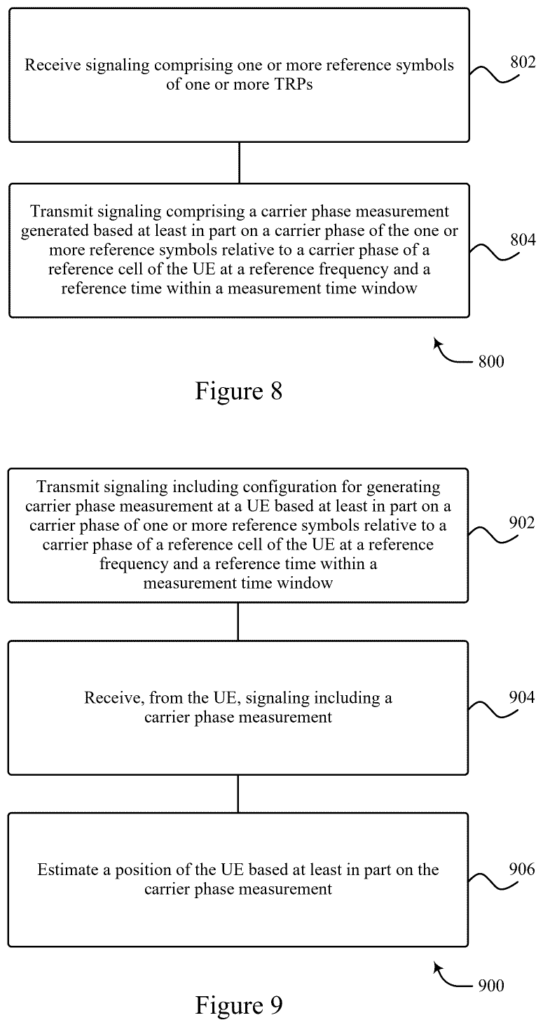

FIG. 8 illustrates a flowchart of a method 800 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 802, the method may include receiving signaling comprising one or more reference symbols of one or more TRPs. The operations of 802 may be performed in accordance with examples as described herein. In some implementations, aspects of the operations of 802 may be performed by a UE as described with reference to FIG. 5.

At 804, the method may include transmitting signaling comprising a carrier phase measurement generated based at least in part on a carrier phase of the one or more reference symbols relative to a carrier phase of a reference cell of the UE at a reference frequency and a reference time within a measurement time window. The operations of 804 may be performed in accordance with examples as described herein. In some implementations, aspects of the operations of 804 may be performed by a UE as described with reference to FIG. 5.

FIG. 9 illustrates a flowchart of a method 900 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 902, the method may include transmitting signaling including configuration for generating carrier phase measurement at a UE based at least in part on a carrier phase of one or more reference symbols relative to a carrier phase of a reference cell of the UE at a reference frequency and a reference time within a measurement time window. The operations of 902 may be performed in accordance with examples as described herein. In some implementations, aspects of the operations of 902 may be performed by a NE as described with reference to FIG. 7.

At 904, the method may include receiving, from the UE, signaling including a carrier phase measurement. The operations of 904 may be performed in accordance with examples as described herein. In some implementations, aspects of the operations of 904 may be performed by a NE as described with reference to FIG. 7.

At 906, the method may include estimating a position of the UE based at least in part on the carrier phase measurement. The operations of 906 may be performed in accordance with examples as described herein. In some implementations, aspects of the operations of 906 may be performed by a NE as described with reference to FIG. 7.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive signaling comprising one or more reference symbols of one or more transmission-reception points (TRPs); and
transmit signaling comprising a carrier phase measurement generated based at least in part on a carrier phase of the one or more reference symbols relative to a carrier phase of a reference cell of the UE at a reference frequency and a reference time within a measurement time window.

2. The UE of claim 1, wherein the reference frequency comprises a center frequency of a positioning frequency layer.

3. The UE of claim 1, wherein the reference time comprises a center of the measurement time window.

4. The UE of claim 3, wherein the reference time is defined according to one or more combinations of symbol index, slot number, slot offset, system frame number, subframe number, coordinated universal time (UTC) time, or global navigation satellite system (GNSS) time.

5. The UE of claim 1, wherein the one or more reference symbols comprise one or more downlink positioning reference signals (PRS).

6. The UE of claim 1, wherein the at least one processor is configured to cause the UE to estimate the carrier phase as a weighted combination of phase estimates of the one or more reference symbols.

7. The UE of claim 6, wherein the phase estimates of the one or more reference symbols are generated based at least in part on one or more of the reference frequency or the reference time.

8. The UE of claim 1, wherein the at least one processor is configured to cause the UE to generate the carrier phase measurement based at least in part on a carrier phase difference of a first carrier phase of a first TRP and a second carrier phase of a second TRP of the one or more TRPs.

9. The UE of claim 8, wherein the at least one processor is configured to cause the UE to determine the first carrier phase and the second carrier phase relative to the carrier phase of the reference cell.

10. The UE of claim 1, wherein the UE is associated with a positioning reference unit (PRU).

11. The UE of claim 1, wherein the at least one processor is configured to cause the UE to receive third signaling comprising one or more of the reference frequency or the reference time.

12. A processor for wireless communication, comprising:
at least one controller coupled with at least one memory and configured to cause the processor to:
receive signaling comprising one or more reference symbols of one or more transmission-reception points (TRPs); and
transmit signaling indicating a carrier phase measurement generated based at least in part on a carrier phase of the one or more reference symbols relative to a carrier phase of a reference cell of a user equipment (UE) at a reference frequency and a reference time within a measurement time window.

13. The processor of claim 12, wherein one or more of:
the reference frequency comprises a center frequency of a positioning frequency layer; or
the reference time comprises a center of the measurement time window.

14. The processor of claim 12, wherein the at least one controller is configured to cause the processor to estimate the carrier phase as a weighted combination of phase estimates of the one or more reference symbols.

15. The processor of claim 14, wherein the phase estimates of the one or more reference symbols are generated based at least in part on the reference frequency and the reference time.

16. The processor of claim 12, wherein the at least one controller is configured to cause the processor to generate the carrier phase measurement based at least in part on a carrier phase difference of a first carrier phase of a first TRP and a second carrier phase of a second TRP of the one or more TRPs.

17. A network equipment for wireless communication, comprising:
at least one memory; and
at least one processor coupled with the at least one memory and configured to cause the network equipment to transmit signaling comprising configuration for generating carrier phase measurement at a user equipment (UE) based at least in part on a carrier phase of one or more reference symbols relative to a carrier phase of a reference cell of the UE at a reference frequency and a reference time within a measurement time window.

18. The network equipment of claim 17, wherein one or more of:
the reference frequency comprises a center frequency of a positioning frequency layer; or
the reference time comprises a center of the measurement time window.

19. The network equipment of claim 17, wherein the at least one processor is configured to cause the network equipment to:
receive, from the UE, signaling comprising a carrier phase measurement; and
estimate a position of the UE based at least in part on the carrier phase measurement.

20. A method performed by a user equipment (UE), the method comprising:
receiving signaling comprising one or more reference symbols of one or more transmission-reception points (TRPs); and
transmitting signaling indicating a carrier phase measurement generated based at least in part on a carrier phase of the one or more reference symbols relative to a carrier phase of a reference cell of the UE at a reference frequency and a reference time within a measurement time window.
